(19) United States
(12) Patent Application Publication
(10) Pub. No.: US 2010/0005806 A1
(43) Pub. Date: Jan. 14, 2010

(54) EDUCTOR SYSTEM FOR A GAS TURBINE ENGINE

(76) Inventor: Brian G. Donnelly, Edenton, NC (US)

Correspondence Address: CARLSON, GASKEY & OLDS/PRATT & WHITNEY, 400 WEST MAPLE ROAD, SUITE 350, BIRMINGHAM, MI, 48009, US

(21) Appl. No.: 12/172,962

(22) Filed: Jul. 14, 2008

(51) Int. Cl. F02K 1/00

(52) U.S. Cl. 60/770

(57) ABSTRACT

A power plant includes a gas turbine engine contained at least partially within an enclosure; an eductor system in communication with the gas turbine engine; and a blower system in communication with the enclosure and the eductor system. A method of communicating an exhaust from a gas turbine engine includes pressurizing a secondary airflow from the enclosure with a blower system and communicating the pressurized secondary airflow into an eductor system.

### BACKGROUND OF THE INVENTION

The present invention relates to a gas turbine engine, and more particularly to an eductor system therefor.

Gas turbine engine power plants are often mounted within an enclosure to reduce acoustic propagation therefrom. A primary airflow communicates with the gas turbine engine and a secondary airflow communicates with the enclosure to provide a cooling airflow for the gas turbine engine. The gas turbine engine generates exhaust products that are expelled through a stack for release to the environment. The secondary air from the enclosure is also exhausted to avoid overheating of engine external equipment and to minimize vapor build-up. An exhaust powered eductor system is to draw the secondary air out of the enclosure and up the stack. If the back pressure of the stack is high, however, the eductor system may not have sufficient capacity at all operating conditions to exhaust the enclosure air. This may be particularly problematic in ships powered by a multiple of gas turbine engines which exhaust though a common stack.

### SUMMARY OF THE INVENTION

A power plant according to an exemplary aspect of the present invention includes an enclosure, a gas turbine engine contained at least partially within the enclosure; an eductor system in communication with the gas turbine engine; and a blower system in communication with the enclosure and the eductor system.

A method of communicating an exhaust from a gas turbine engine according to an exemplary aspect of the present invention including: communicating a primary airflow into a gas turbine engine; communicating a secondary airflow into an enclosure which at least partially contains the gas turbine engine; communicating an exhaust flow from the gas turbine engine into an eductor system; pressurizing the secondary airflow from the enclosure with a blower system; and communicating the pressurized secondary airflow into the eductor system.

### BRIEF DESCRIPTION OF THE DRAWINGS

The various features and advantages of this invention will become apparent to those skilled in the art from the following detailed description of the disclosed non-limiting embodiment. The drawings that accompany the detailed description can be briefly described as follows:

FIG. 1 is a block diagram of a gas turbine engine power plant for use with one embodiment of the of the present invention; and

FIG. 2 is a block diagram of a primary and secondary airflow from a power plant according to one embodiment of the present invention.

### DETAILED DESCRIPTION OF THE DISCLOSED EMBODIMENT

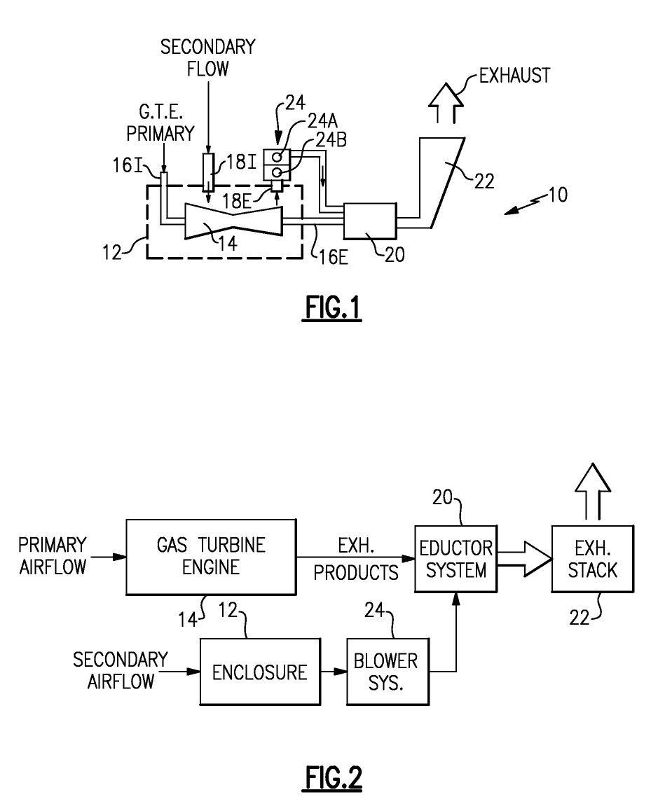

FIG. 1 schematically illustrates a power plant 10. The power plant 10 may be utilized in a marine vehicle, a land vehicle, a stationary power generation plant or other system with an enclosed powerplant.

The power plant 10 includes a gas turbine engine 14 within an enclosure 12. A primary air inlet 161 communicates with the gas turbine engine 14 to provide a primary airflow path into the gas turbine engine 14. A secondary air inlet 181 communicates with the enclosure 12 to provide a cooling airflow path for the gas turbine engine 14.

The gas turbine engine 14 communicates an exhaust flow through a primary exhaust duct 16E, an eductor system 20, and an exhaust stack 22. A blower system 24 communicates with the eductor 20 to communicate the secondary airflow from the enclosure 12 and utilize the kinetic energy of the secondary airflow to facilitate the flow of the gas turbine engine exhaust. That is, the blower system 24 essentially supercharges the gas turbine engine exhaust product.

The blower system 18 may include a multiple of blowers 24A, 24B for redundancy or arrangement requirements to facilitate operation over a wide range of engine power and stack back pressure. The blower system 24 also allows the enclosure 12 to avoid significant pressurization as contrasted with conventional enclosures which utilize fan systems for cooling. That is, the secondary airflow is pressurized, not the enclosure 12. The reduction or elimination of pressurization allows for the reduction in enclosure structural support and a thereby lighter weight enclosure 12.

Referring to FIG. 2, secondary flow is communicated from the enclosure 12, pressurized by the blower system 24 and exhausted into the eductor system 20. Simultaneous therewith, primary flow is communicated to the gas turbine engine which generates exhaust products. The exhaust product flow is communicated from the gas turbine engine 14, through the eductor system 20, and exhausted through the exhaust stack 22.

Although particular step sequences are shown, described, and claimed, it should be understood that steps may be performed in any order, separated or combined unless otherwise indicated and will still benefit from the present invention.

The foregoing description is exemplary rather than defined by the limitations within. Many modifications and variations of the present invention are possible in light of the above teachings. The disclosed embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A power plant comprising:
an enclosure;
a gas turbine engine contained at least partially within said enclosure;
an eductor system in communication with said gas turbine engine; and
a blower system in communication with said enclosure and said eductor system.

2. The power plant as recited in claim 1, further comprising an exhaust stack in communication with said eductor system.

3. The power plant as recited in claim 1, wherein said blower system comprises a multiple of blowers.

4. The power plant as recited in claim 1, wherein said enclosure is unpressurized.

5. The power plant as recited in claim 1, further comprising a primary inlet in communication with said gas turbine engine.

6. The power plant as recited in claim 5, further comprising a secondary inlet in communication with said enclosure.

7. The power plant as recited in claim 1, wherein said enclosure forms a section of a vehicle.

8. The power plant as recited in claim 1, wherein said vehicle comprises a ship.

9. A method of communicating an exhaust from a gas turbine engine comprising:
communicating a primary airflow into a gas turbine engine;
communicating a secondary airflow into an enclosure which at least partially contains the gas turbine engine;
communicating an exhaust flow from the gas turbine engine into an eductor system;
pressurizing the secondary airflow from the enclosure with a blower system; and
communicating the pressurized secondary airflow into the eductor system.

10. A method as recited in claim 9, further comprising:
maintaining the enclosure in an unpressurized condition.

11. A method as recited in claim 9, further comprising:
communicating the exhaust flow and the secondary airflow from the eductor system into an exhaust stack.
